(19) United States
(12) Patent Application Publication
(10) Pub. No.: US 2021/0080097 A1
(43) Pub. Date: Mar. 18, 2021

(54) CONVERSION ADAPTER FOR POOL AND SPA LIGHTING HARDWARE

(71) Applicant: Troy Becker, Ojai, CA (US)

(72) Inventor: Troy Becker, Ojai, CA (US)

(21) Appl. No.: 16/890,397

(22) Filed: Jun. 2, 2020

Related U.S. Application Data
(63) Continuation-in-part of application No. 29/705,610, filed on Sep. 13, 2019.
Application No. 29/705,610 is a continuation-in-part of application No. 29/705,518, filed on Sep. 12, 2019.
(60) Provisional application No. 62/901,500, filed on Sep. 17, 2019.

(51) Int. Cl. F21V 31/00; F21S 8/02; F21K 9/237

(52) U.S. Cl. CPC F21V 31/00; F21Y 2115/10; F21K 9/237; F21S 8/024

(57) ABSTRACT

An LED assembly is installed to a larger spa or pool light niche by inserting at least a portion of the LED light assembly through a receiving aperture of an adapter plate, and attaching the LED light assembly to the adapter. The adapter is mounted to the spa or pool light niche, such that it substantially covers the open end of the spa or pool niche. An outer face of the plate may be generally planar and solid. Alternatively, the plate may have a peripheral lip defining at least one open-faced cavity that receives a fill material therein which may have appearance characteristics of a submerged surface of the pool or spa.

### RELATED APPLICATIONS

This application claims the benefit of U.S. Provisional Application No. 62/901,500, filed on Sep. 17, 2019. This application also claims priority to U.S. Design Application Serial No. 29/705,518, filed Sep. 12, 2019, and U.S. Design Application Serial No. 29/705,610, filed Sep. 13, 2019.

### BACKGROUND OF THE INVENTION

The present invention generally relates to spa and pool lighting. More particularly, the present invention relates to a device and method for adapting large light bulbs fixtures in pools and spas to fit smaller, more efficient light fixtures.

For many decades, the lighting in pools and spas has been mostly large incandescent bulbs. As those bulbs wear out, they need to be replaced. An expired bulb has been traditionally replaced with an incandescent or fluorescent light bulb of the same size, which fits directly into the existing conventional light hardware.

More recently, a number of LED based lighting options have been developed for pools and spas. These new lighting solutions are desirable primarily because they are more energy efficient, cost less to run, and tend to last longer. They have become standard in most new pool and spa construction. However, many LED bulb options are not sized appropriately to fit directly into the conventional light fixtures found in older pools and spas.

Installing most new LED bulbs or fixtures into older pools and spas generally requires several expensive and time-consuming modifications. These modifications often include removing all the existing light hardware, installing an entirely new smaller light hardware assembly, and then patching the area around the light hardware assembly to match the surrounding pool material. In some cases, it may also be necessary to create an entirely new installation point for lighting hardware in a pool or spa by coring the vessel wall, running new conduit, installing new lighting hardware, sealing around all new hardware, and then installing a new LED light. The benefits of using LED lighting are substantial enough that some owners will accommodate the extensive work required retrofit and/or replace traditional lighting systems, or even install entirely new lighting, in their older pools and spas.

Accordingly, there is a need for a simple and effective way to facilitate using smaller, more efficient, lighting solutions in older pools and spas by retrofitting a conventional light hardware assembly, and avoiding the need to remove and replace existing light hardware or freshly install a new light hardware assembly. The present invention fulfills these needs, and provides other related advantages.

### SUMMARY OF THE INVENTION

It is the object of the present invention to provide a device and method to effectively and easily replace larger traditional light bulbs in pools and spas with smaller, more efficient light bulbs or fixtures, such as LED lights. The invention achieves the above objective by providing an apparatus and methodology for replacing large, conventional incandescent light bulbs with smaller, more cost effect LED lights without having to remove or replace the existing installed light hardware.

The present invention resides in an adapter for installing an LED assembly to a larger spa or pool light housing or niche. The adapter generally comprises an annular plate sized to cover an open end of a spa or pool light niche. An LED assembly receiving aperture extends through the plate. At least one mounting member is associated with the plate that mounts the plate to the spa or pool light niche such that the adapter plate substantially covers the open end of the spa or pool niche.

The receiving aperture of the plate may have internal threads. These threads engage external threads of the LED assembly for attaching the LED assembly to the plate. The receiving aperture of the plate may also be smooth, and the LED assembly either frictionally fit or otherwise attached to the adapter plate. It is also contemplated by the present invention that when the LED assembly is of a smaller diameter than the receiving aperture of the plate, that a bushing be used that is disposed between the receiving aperture and the LED assembly so as to retain the LED assembly in place.

The at least one mounting member may comprise a fastener threadedly received through a threaded aperture formed in the plate, and alignable with an aperture of a light ring associated with the spa or pool light niche. Alternatively, or additionally, the mounting member may comprise a protrusion extending from the plate and forming a slot configured to receive a tab of a light ring associated with a spa or pool light niche.

In one form, the plate comprises a generally planar and solid outer face. In another form, the plate has a peripheral lip defining at least one open-faced cavity on a front face thereof that receives a fill material therein having appearance characteristics of a submerged surface of the pool or spa. A plurality of dividers may extend inwardly from the peripheral lip of the plate to form a plurality of fill material-receiving cavities.

A method for installing an LED assembly to a larger spa or pool light niche, in accordance with the present invention, comprises providing an adapter comprising a plate sized to cover an open end of a spa or pool light niche. The plate has an LED assembly-receiving aperture therethrough. At least a portion of an LED light assembly is passed through the receiving aperture of the plate. The LED light assembly is attached to the adapter. The adapter is mounted to the spa or pool light niche, such that the plate substantially covers the open end of the spa or pool niche.

The LED assembly may be attached to the adapter by threadedly connecting a portion of the LED assembly to internal threads of the receiving aperture of the plate. The LED assembly may be connected to the adapter such that an illuminating end thereof is substantially flush with an outer face of the plate. The mounting step may comprise the step of mounting the adapter to the spa or pool niche such than an outer surface of the plate is substantially flush with an exposed surface of a wall forming the spa or pool.

The mounting step may comprise inserting a fastener through aligned apertures of the adapter and a light ring associated with the spa or pool niche. Alternatively, or additionally, the mounting step may comprise inserting a tab of the light ring associated with the spa or pool niche into a slot of the adapter.

The plate may have a peripheral lip defining at least one open-faced fill material-receiving cavity on a front face thereof. Dividers may extend inwardly from the peripheral lip of the plate to form a plurality of fill material-receiving cavities. A fill material is inserted into these one or more cavities of the plate. Preferably, the fill material has similar appearance characteristics of the submerged surface lining the spa or pool.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an exploded perspective view of an adapter plate embodying the present invention, and other components for installing an LED assembly into a spa or pool light niche;

FIG. 2 is a front perspective view of an adapter plate embodying the present invention;

FIG. 3 is a back perspective view of the adapter plate of FIG. 2;

FIG. 4 is an exploded perspective view illustrating the adapter plate connectable to a light ring associated with the spa or pool light niche;

FIG. 5 is a cross-sectional view illustrating the assembly of the components of FIG. 1 to the spa or pool light niche;

FIG. 6 is a front elevational view of FIG. 5;

FIG. 7 is a front perspective and exploded view illustrating another adapter plate of the present invention and other components for installing an LED assembly to a spa or pool light niche;

FIG. 8 is a front perspective view of the adapter plate of FIG. 7;

FIG. 9 is a rear perspective view of the adapter plate of FIGS. 7 and 8;

FIG. 10 is an exploded perspective view illustrating the adapter plate connectable to a light ring of the spa or pool light niche;

FIG. 11 is a front elevational view illustrating the assembly of the components of FIG. 7;

FIG. 12 is a view similar to FIG. 11, but illustrating the cavities of the adapter plate being filled with fill material, in accordance with the present invention; and

FIG. 13 is an exploded perspective view illustrating the adapter plate of the present invention as well as a bushing used to accommodate LED assemblies of smaller size.

### DETAILED DESCRIPTION OF THE PREFERRED EMBODIMENTS

As shown in the accompanying drawings, for purposes of illustration, the present invention is directed to a conversion adapter for converting or adapting large light bulb fixtures in pools and spas to fit smaller, more efficient light bulbs, such as LED assemblies. Using the conversion adapter and method of the present invention enables one to use smaller, more efficient lighting solutions in older pools and spas by retrofitting a conventional light hardware assembly and avoiding the need to remove and replace existing light hardware or freshly install a new light hardware assembly, which might otherwise require hatching the area around the light hardware assembly to match the surrounding pool material. The present invention provides the benefits of the more efficient light bulbs, such as LED lighting, without the need of installing entirely new lighting, retrofitting, or replacing traditional lighting systems and avoids the drawbacks associated with such traditional replacements and retrofits.

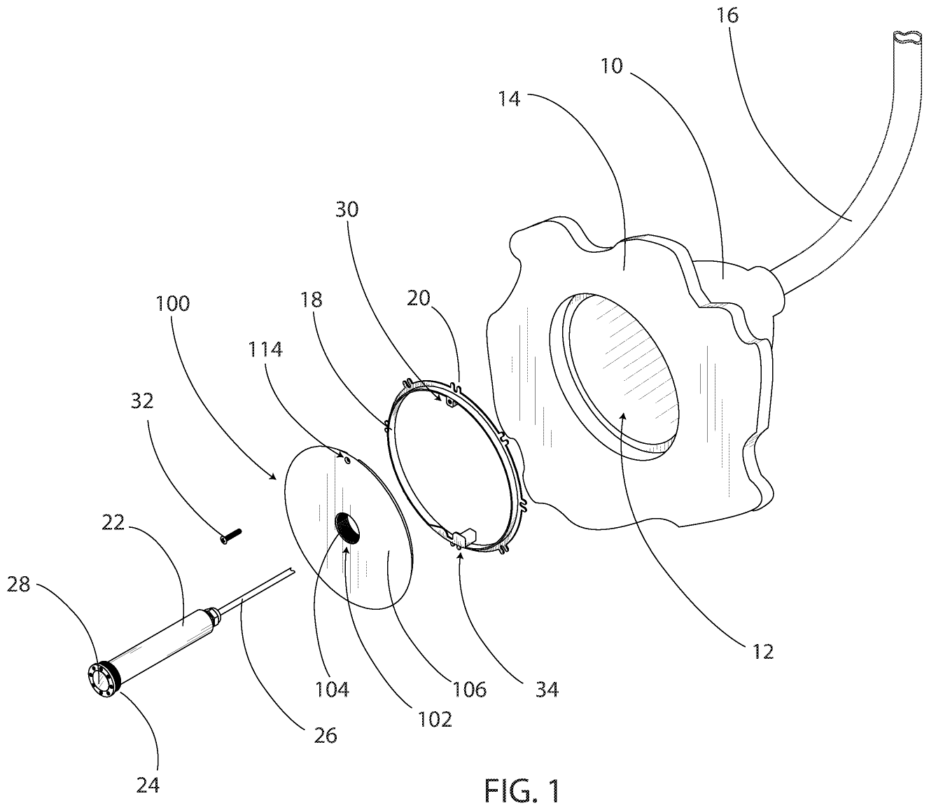

With reference now to FIG. 1, in-ground pool or spa lighting hardware is well known and is comprised of several components. When constructing the pool or spa, the swimming pool lights or spa lights require a light niche 10, or housing, for the light to sit in. Light niches are typically comprised of plastic (PVC) or metal, such as typically stainless steel. A light niche is used in all pool types, whether they be vinyl, fiberglass, concrete or gunite. An open end 12 of the light niche 10 extends through the inner surface 14 of the pool and spa, or an aperture is formed in the inner surface 14 so that the open end 12 of the niche 10 is accessible. An electrical conduit 16 extends from the niche 10 to a power source (not shown). The electrical conduit 16 houses and protects the electrical wiring that connects the lightbulb to the power source.

In accordance with the present invention, the old incandescent bulb or light fixture is removed from the niche 10 or housing, along with the electrical wires of the lightbulb, as necessary. FIG. 1 illustrates the incandescent bulb already removed from the niche 10. A light mounting ring 18 may need to be removed from the outer peripheral edge of the niche 10 in order to remove the incandescent bulb. Oftentimes, the light mounting ring 18 will include a plurality of spaced-apart tabs 20 which receive bolts or screws or other fasteners therethrough and into aligned apertures of the niche 10 so as to secure the light mounting ring 18 onto the niche 10. In other instances, however, the light mounting ring 18 may not need to be removed, and the tabs 20 will be permanently installed to the light niche 10, and in some cases even plastered over with the inner pool surface material 14.

An exemplary new and more efficient lightbulb fixture 22, typically comprising an LED assembly, is shown in FIG. 1. Typically, such new LED assembly 22 is of a much smaller diameter or size than the opening 12 of the niche 10. Without the benefit of the present invention, installation of the newer and more efficient light assembly 22 would require that the existing niche 10 be removed from the pool or spa and a smaller and more appropriately-sized niche be inserted in its place. Of course, this would require alteration and re-plastering of the inner surface 14 or lining of the pool or spa, which is undesirable. In some cases, such as a vinyl or fiberglass pool or the like, replacing the existing niche 10 with a smaller niche is not feasible, and thus the newer and more efficient light assemblies are unable to be used.

However, in accordance with the present invention, an adapter 100, in the form of a plate, is provided which is sized and configured to cover the open end 12 of the pool or spa light niche 10. Typically, as illustrated, the adapter plate 100 is circular. A receiving aperture 102 is formed through the adapter plate 100 through which the LED assembly 22 may be inserted. The receiving aperture 102 may include internal threads 104 which threadedly engage external threads 24 of the LED assembly 22, so as to attach the LED assembly 22 thereto. However, it will be appreciated that other means of attaching the LED assembly 22 to the adapter plate 100 are contemplated by the present invention, such as by a frictional fit, use of adhesive, or other attachment means.

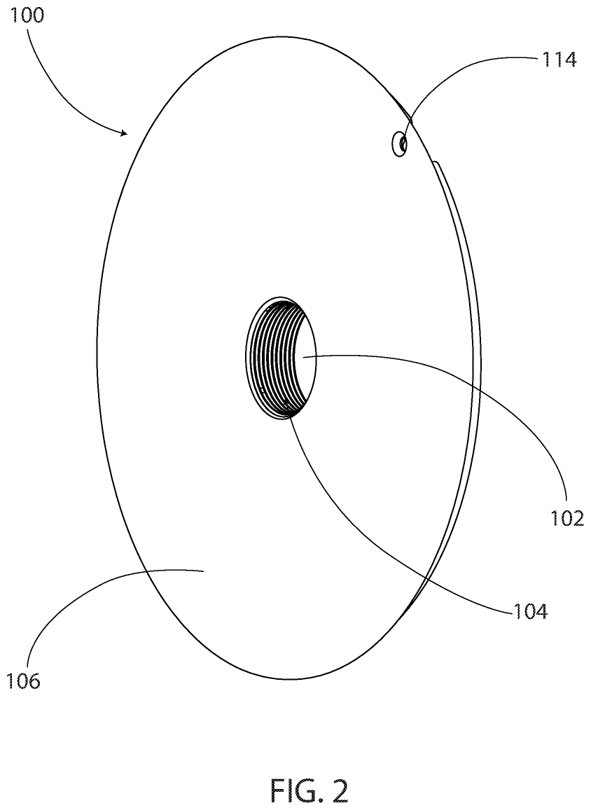

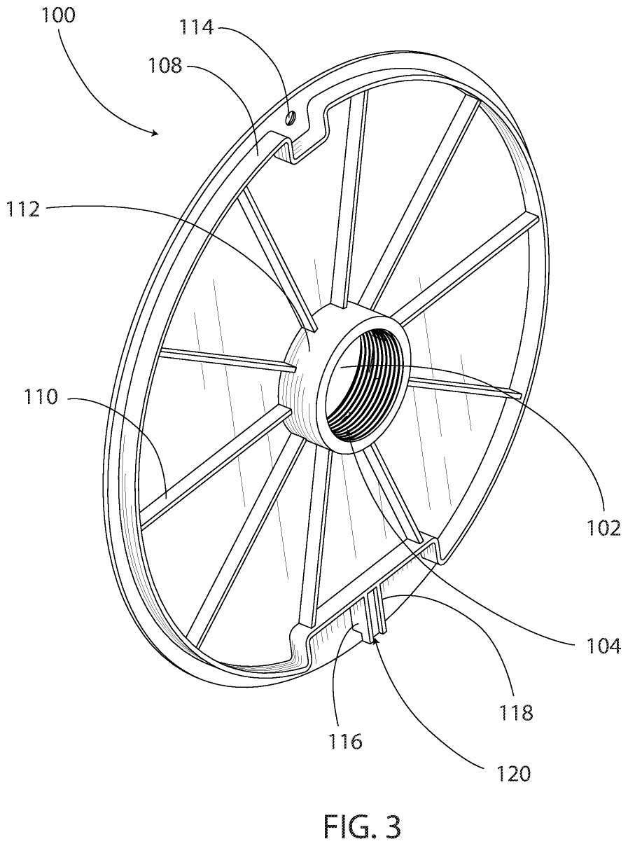

With reference now to FIGS. 2 and 3, front and rear perspective views of the adapter plate 100 of FIG. 1 are illustrated. As illustrated in FIG. 2, the adapter plate 100 comprises a generally planar outer face 106. The adapter plate 100 may be comprised of any appropriate material, but is typically comprised of plastic. In the embodiment illustrated in FIGS. 1-6, the front face 106 of the adapter plate 100 is generally solid and planar.

With reference now to FIG. 3, the adapter plate 100 may include a rear peripheral lip 108, which is generally sized so as to fit within the light mounting ring 18. Ribs 110 may extend from the peripheral lip 108 to a hub 112, which defines the receiving aperture 102 to provide rigidity and support to the adapter plate 100.

With reference again to FIG. 1, the LED assembly, or new light assembly 22, has electrical wires 26 which are fed through the receiving aperture 102, and into conduit 16 of the light niche 10, or extending out the light niche 10 to the power source. The body of the LED assembly 22 is also inserted through the receiving aperture 102 until, in the embodiment illustrated in FIG. 1, the external threads 24 of the LED assembly 22 come into engagement with, and then are threaded with the internal threads 104 of the receiving aperture 102. The LED assembly 22 is threadedly attached, or otherwise attached, to the adapter plate 100 until a front or outer face 28 of the LED assembly 22 is properly positioned, typically substantially co-planar with the outer surface 106 of the adapter plate 100, or slightly embedded into or extending from the outer surface 106 of the adapter plate 100.

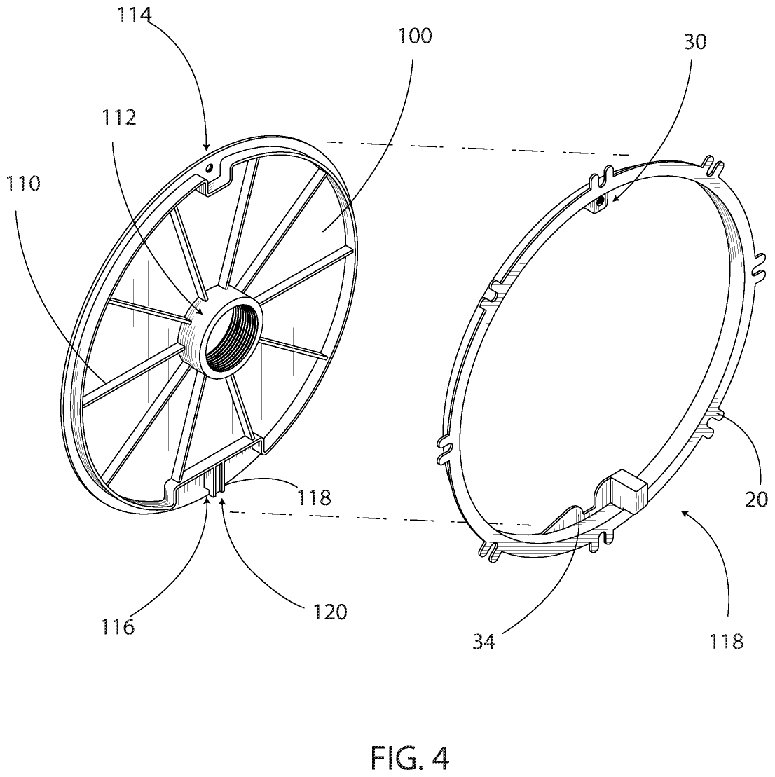

With reference now to FIG. 4, the adapter plate 100 is attached to the light mounting ring 18, and thus to the light niche 10. At least one mounting member is associated with the adapter plate 100 to mount the adapter plate to the spa or pool light niche, such that the adapter plate 100 substantially covers the open end 12 of the spa or pool niche. As illustrated, the light mounting ring 18 includes an internally threaded aperture 30 for mounting purposes. The adapter plate has a corresponding aperture 114 through which a fastener 32, such as a small bolt or screw can be inserted through and into the internally threaded aperture 30 of the light mounting ring so as to attach and secure the adapter plate 100 to the light mounting ring 18, and thus to the light niche 10. The light mounting ring may also include a mounting tab 34. As illustrated in FIGS. 3 and 4, a rear side of the adapter plate 100 includes spaced apart protrusions or keys 116 and 118 defining a slot 120 which is sized and configured so as to receive the tab 34 of the light mounting ring 18 therein to further mount and attach the adapter plate 100 to the light mounting ring 18.

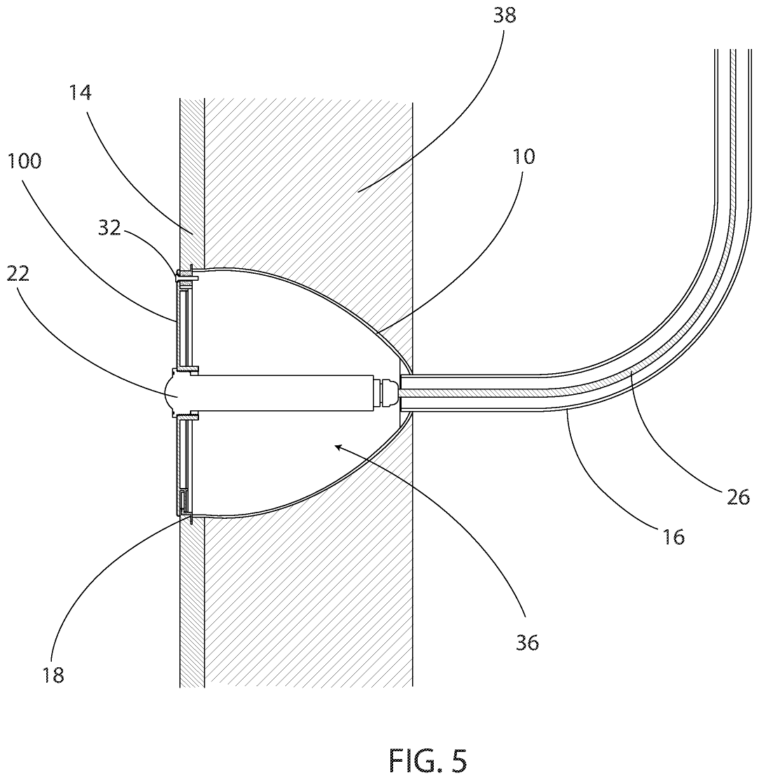

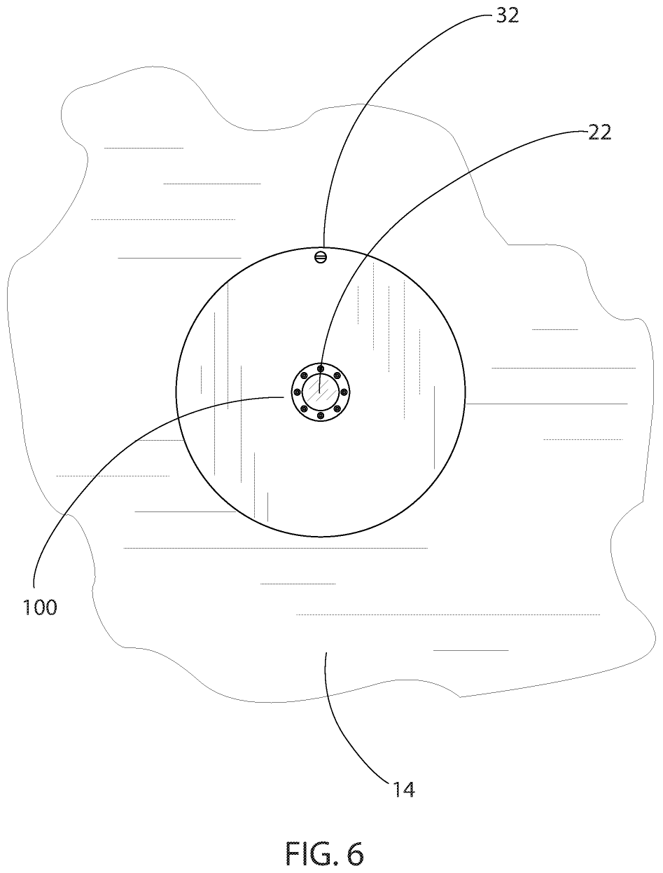

With reference now to FIG. 5, a cross-sectional view of the assembled parts and components illustrated in FIG. 1 is shown. It can be seen that the adapter plate 100 has been connected to the mounting ring 18, and thus the outer end of the niche 10. Much of the body of the LED assembly 22 resides within the cavity 36 of the niche 10. The electrical wires 26 of the LED assembly 22 extend through the conduit 16 to the power source. It can also be seen in FIG. 5 that a wall 38 of the pool or spa houses the light niche 10, and in many pools and spas, particularly those comprised of concrete or gunite, have an inner surface layer 14. Alternatively, reference number 38 could represent the ground or other structure of the pool or spa, and reference number 14 the inner layer defining the pool or spa. FIG. 6 is a front elevational view of FIG. 5, illustrating the adapter plate 100 covering the open end 12 of the niche 10 and supporting the LED light assembly 22 therein, as would be viewed from the inside of the pool or spa.

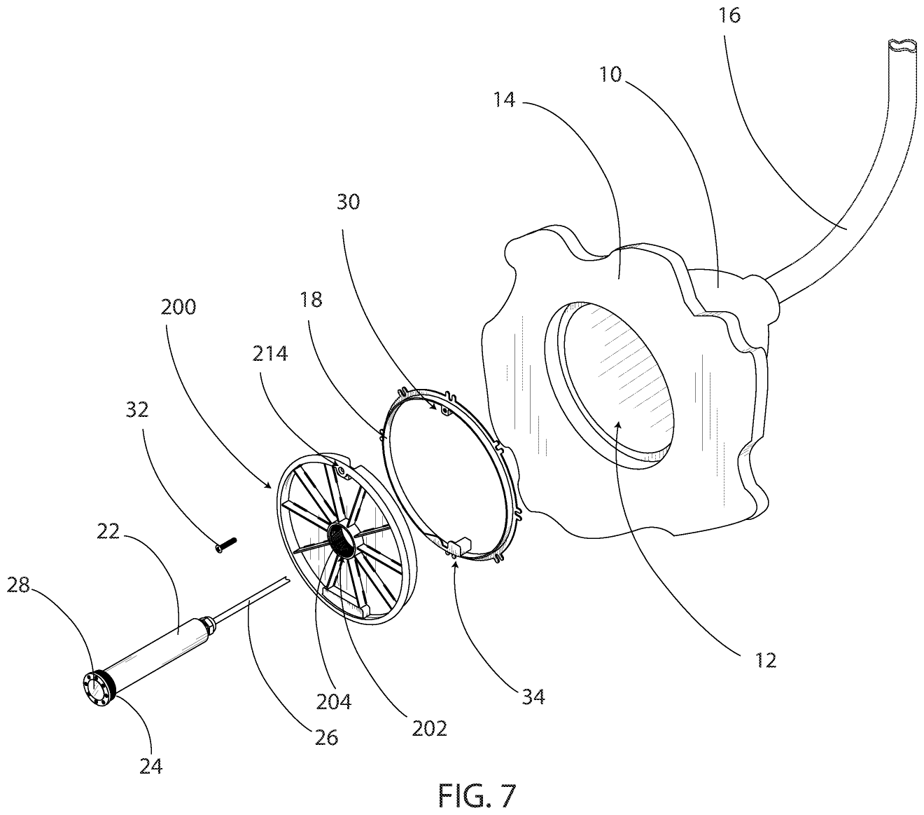

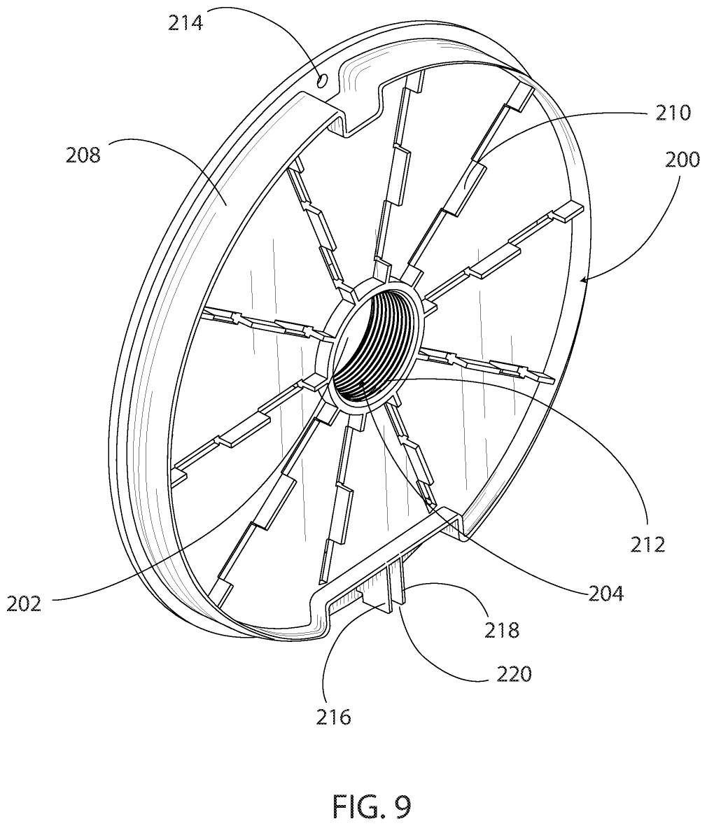

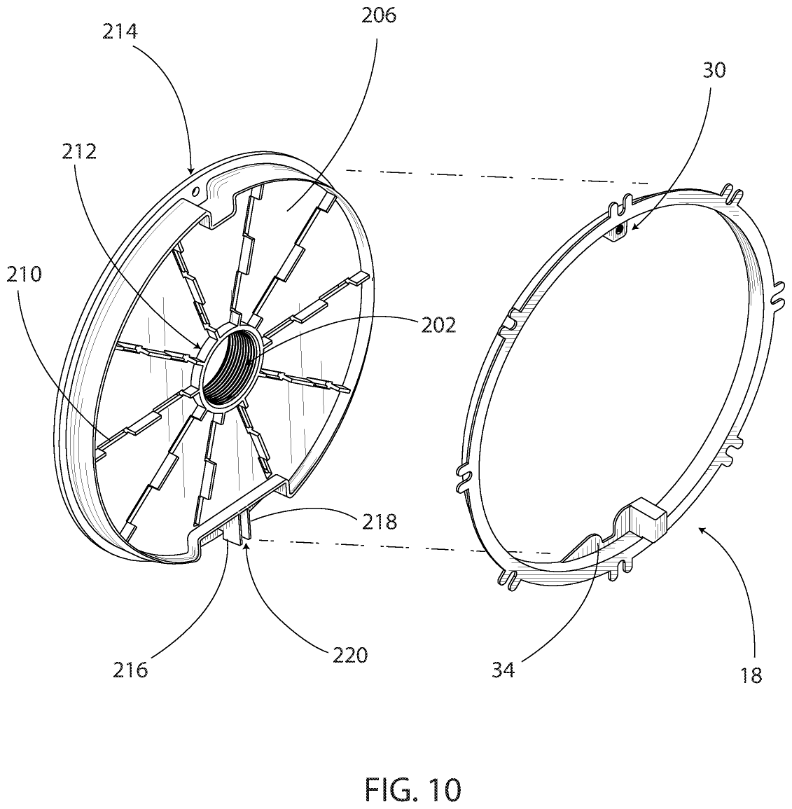

As can be seen in FIG. 6, the external surface 106 of the adapter plate 100 will be visible inside of the pool or spa. It may be desirable, however, to hide the adapter plate 100 and instead have the installation have an appearance as if the new light assembly 22 was completely installed and retrofitted to the pool or spa, such that only the outer surface of the LED assembly 22 is visible, as would be the case if the original niche 10 were removed and replaced with a smaller niche to specifically accommodate the newer and smaller LED light assembly 22. With reference to FIGS. 7-12, modified adapter plate 200 is provided and shown to accomplish these purposes.

As can be seen in FIGS. 7-12, the adapter plate 200 serves the same purpose as the adapter plate 100 described above in that it is an annular plate sized to cover an open end 12 of the spa or pool light niche 10. The adapter plate 200 also includes a receiving aperture 202 therethrough, configured to receive the LED or other new light assembly 22 therethrough. Internal threads 204 threadedly engage external threads 24 of the LED assembly 22 so as to be attached thereto. The adapter plate 200 is attached to the light mounting ring 18, such as by inserting a fastener 32 through aligned apertures 214 of the adapter plate 200 and 30 of the mounting ring 18. Tab 34 is insertable into slot 220, defined by key protrusions 216 and 218. An inner rear lip 208 of the adapter plate 200 will fit inside of the mounting ring 18. Structural ribs 210 may be formed on the back side of the adapter plate 200, such as extending between the lip 208 and central hub 212, defining the receiving aperture 202.

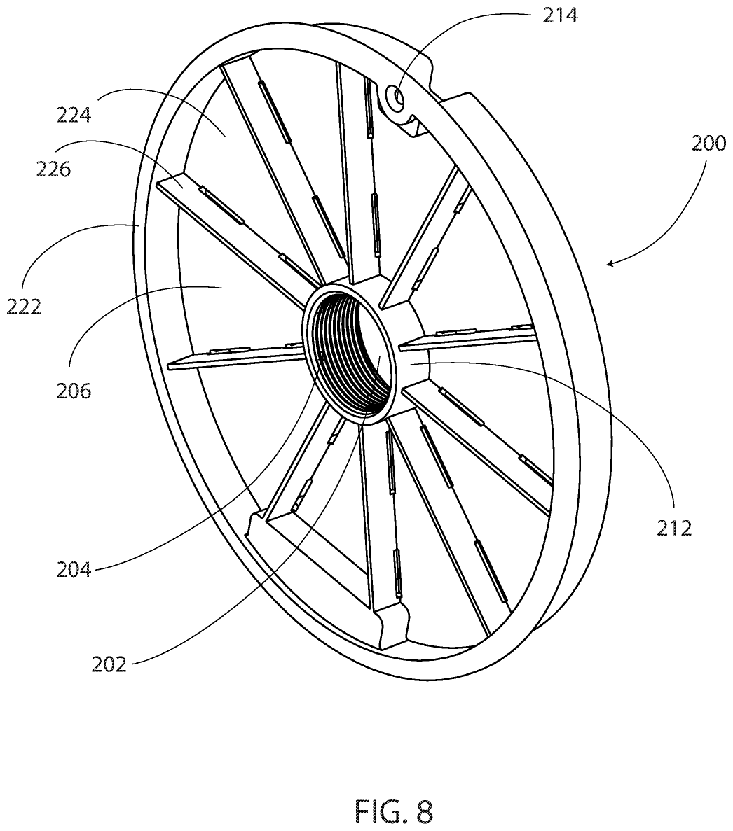

In accordance with this embodiment, however, the adapter plate 200, as illustrated in FIGS. 7 and 8, has a base or dividing plate 206 which is recessed with respect to a front outer peripheral lip 222 so as to define at least one open-faced cavity 224. The open-faced cavity 224 receives a fill material therein, which may have the appearance and characteristics of a submerged surface 14 of the pool or spa. Preferably, a plurality of dividers 226 extend from the front peripheral lip 222 and inward toward the receiving aperture 202, such as connecting hub 212. It will be appreciated that the dividers 226 may have configurations other than that illustrated, and the purpose of the dividers is to divide the open-faced cavity 224 into a plurality of smaller open-faced cavities which receive the fill material, such as plaster grout or the like therein. Use of the smaller cavities facilitates retention of the fill material with the cavities. It will be seen that the dividers 226 have a height which is less than the outer peripheral edge 222, such that the dividers 226 may be completely encapsulated and hid within the fill material.

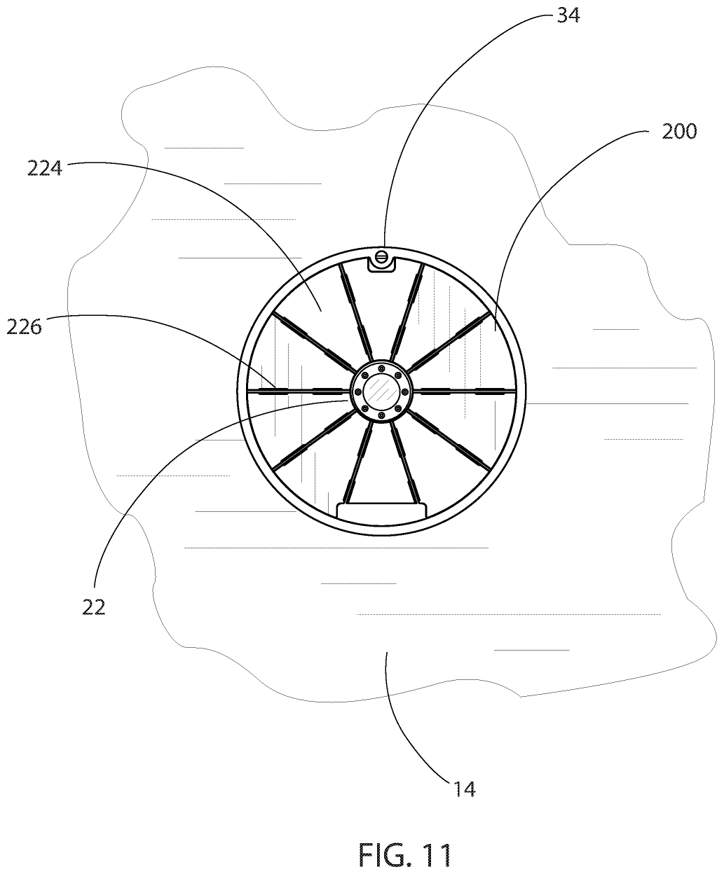

The components illustrated in FIG. 7 are assembled and interconnected, as described above, such as in relation to FIGS. 1 and 5. FIG. 11 illustrates a front elevational view of the embodiment illustrated in FIG. 7, but assembled, without any of the fill material, in the form of plaster, grout or the like applied thereto. While this may be done in the case where the water of the pool or spa has been drained, and thus the fill material may be applied to one or more open cavities 224 of the adapter plate 200. Typically, however, the fill material 228 will be applied to the adapter plate 200 so as to fill the open cavities 224 prior to the adapter plate 200 and other components being assembled to one another. This may be, for example, exterior to the pool, with the fill material allowed to harden and/or cure before the components are assembled.

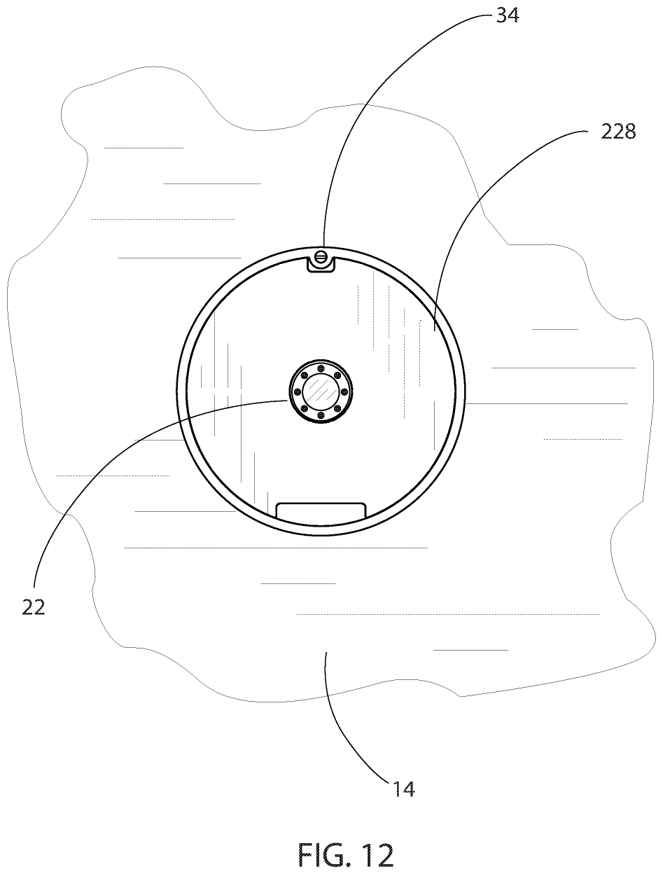

FIG. 12 is an environmental front view of the adapter plate 200 having the cavities 224 filled with fill material 228, in accordance with the present invention. Preferably, the fill material is comprised of a material having a similar appearance and/or characteristic as the submerged inner surface 14 of the pool or spa, so as to conceal the adapter plate 200 and provide the appearance of a more finished look. Thus, from inside the pool or spa, the front face 28 of the LED or other light assembly 22 will be visible. It is also possible that the peripheral lip 222 is visible from inside of the pool or spa, although this will be but a small ring and thus the majority of the surface will appear as a continuous surface as to the inner surface 14 of the pool or spa. It is also contemplated by the present invention that lip 222 could be configured such, such as being slightly recessed, that fill material, in the form of plaster, grout or the like, could be applied over the lip 222 after installation so as to provide even a cleaner and more refined appearance.

As described above, the adapter plate 100 or 102 may include internal threads 104 or 204 within the receiving aperture 102 or 202 for threadedly receiving external threads 24 of the LED or other light assembly 22 such that the LED assembly 22 could be attached to the light adapter. However, other attachment means are contemplated by the present invention. For example, other mechanical attachments may be provided. An outer surface of the LED assembly 22 may have a frictional fit with the inner surface of the receiving aperture of the adapter plate. In such a case, the inner surface of the receiving aperture may be smooth instead of threaded. It is also contemplated by the present invention that adhesive or the like be used to attach and affix the LED assembly 22 to the adapter plate.

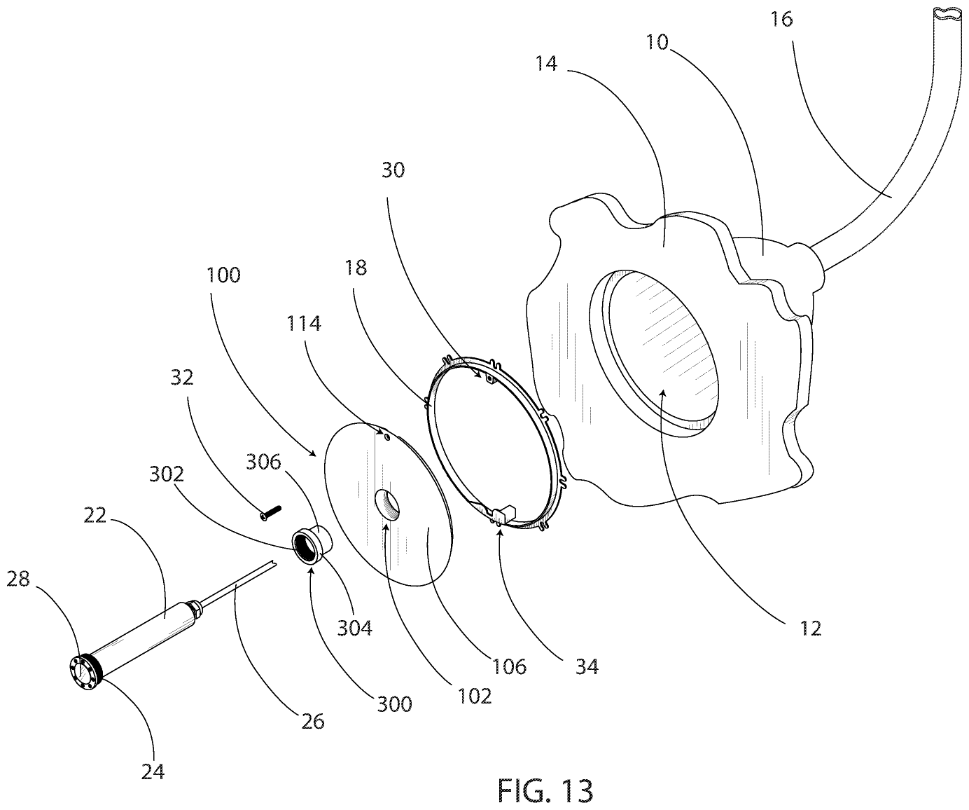

LED assemblies 22 can come in a variety of sizes and configurations. Increasingly, such LED assemblies 22 are becoming smaller in size. While adapter plates having receiving apertures which are smaller in diameter or different in configuration could be produced in order to accommodate such smaller or varying sized LED assemblies 22, the present invention contemplates the use of a bushing 300 which would permit a given adapter plate to be used in conjunction with a variety of LED assemblies 22. As shown in FIG. 13, the bushing 300 would be disposed between the adapter plate 100 and the LED assembly 22. The bushing 300 would form a passageway through which the LED assembly 22 would pass. The bushing 300 may include internal threads 302 for engaging the external threads 24 of the LED assembly. A shoulder 304 of the bushing 300 may rest upon the area of the adapter plate surrounding the receiving aperture, which would present an area to adhere the bushing 300 to the adapter plate. A sleeve 306 of the bushing 300 may form a frictional fit with an inner surface of the receiving aperture. Alternatively, the sleeve 306 may have external threads, not shown, which would engage internal threads of the receiving aperture of the adapter plate. Bushings could be provided in different sizes, or thicknesses, so as to accommodate LED assemblies 22 of varying sizes and diameters so as to couple and attach them to the adapter plate. In this manner, an installer may need only stock one type of adapter plate 100 or 200, with a variety of different sized or configured bushings 300 to accommodate LED assemblies of varying sizes.

Although several embodiments have been described in detail for purposes of illustration, various modifications may be made without departing from the scope and spirit of the invention. Accordingly, the invention is not to be limited, except as by the appended claims.

What is claimed is:

1. A method for installing an LED assembly to a larger spa or pool light niche, comprising the steps of:
providing an adapter plate sized to cover an open end of a spa or pool light niche, the adapter plate having an LED assembly receiving aperture therethrough;
inserting at least a portion of an LED light assembly through the receiving aperture of the adapter plate and attaching the LED light assembly to the adapter plate;
mounting the adapter plate to the spa or pool light niche such that the adapter plate substantially covers the open end of the spa or pool niche.

2. The method of claim 1, wherein the attaching the LED assembly to the adapter step includes the step of threadedly connecting the LED assembly to internal threads of the receiving aperture of the adapter plate.

3. The method of claim 1, wherein the LED assembly is connected to the adapter plate such that an illuminating end thereof is substantially flush with an outer face of the adapter plate.

4. The method of claim 1, wherein the mounting step comprises inserting a fastener through aligned apertures of the adapter plate and a light ring associated with the spa or pool niche.

5. The method of claim 1, wherein the mounting step comprises inserting a tab of a light ring associated with the spa or pool niche into a slot of the adapter plate.

6. The method of claim 1, wherein the mounting step comprises inserting a fastener through aligned apertures of the adapter plate and a light ring associated with the spa or pool niche and inserting a tab of the light ring into a slot of the adapter plate.

7. The method of claim 1, wherein the mounting step comprises mounting the adapter plate to the spa or pool niche such that an outer surface of the adapter plate is substantially flush with an exposed surface of a wall forming the spa or pool.

8. The method of claim 1, wherein the adapter plate has a peripheral lip defining at least one open-faced fill material receiving cavity on a front face thereof.

9. The method of claim 8, including a plurality of dividers extending inwardly from the peripheral lip of the adapter plate and forming a plurality of fill material receiving cavities.

10. The method of claim 8, including the step of inserting a fill material into the at least one cavity of the adapter plate.

11. The method of claim 10, wherein the fill material has similar appearance characteristics of a submerged surface lining the spa or pool.

12. The method of claim 1, including inserting a bushing between the receiving aperture of the plate and the LED assembly.

13. An adapter for installing an LED assembly to a larger spa or pool light niche, comprising:
an annular plate sized to cover an open end of a spa or pool light niche;
an LED assembly receiving aperture extending through the plate;
at least one mounting member associated with the plate that mount the plate to the spa or pool light niche such that the adapter plate substantially covers the open end of the spa or pool niche.

14. The adapter of claim 13, wherein the receiving aperture of the plate has internal threads that engage external threads of an LED assembly for attaching the LED assembly to the plate.

15. The adapter of claim 13, wherein the at least one mounting member comprises a fastener threadedly received through a threaded aperture formed in the plate and alignable with an aperture of a light ring associated with the spa or pool light niche.

16. The adapter of claim 13, wherein the at least one mounting member comprises a protrusion extending from the plate and forming a slot configured to receive a tab of a light ring associated with the spa or pool light niche.

17. The adapter of claim 13, wherein the plate comprises a generally planar outer face.

18. The adapter of claim 13, wherein the plate has a peripheral lip defining at least one open-faced cavity on a front face thereof that receives a fill material therein having appearance characteristics of a submerged surface of the pool or spa.

19. The adapter of claim 18, including a plurality of dividers extending inwardly from the peripheral lip of the plate and forming a plurality of fill material receiving cavities.

20. The adapter of claim 13, including a bushing disposed between the receiving aperture of the plate and an LED assembly.
